(19) United States
(12) Patent Application Publication
(10) Pub. No.: US 2022/0403151 A1
(43) Pub. Date: Dec. 22, 2022

(54) POLYETHYLENE COPOLYMER BLEND

(71) Applicant: Dow Global Technologies LLC, Midland, MI (US)

(72) Inventors: Yichi Zhang, Novi, MI (US); Raghunath Roy, Collegeville, PA (US); Wayne C. Whelchel, Wilmington, DE (US); Barry A. Morris, Wilmington, DE (US); Xian Jiang, Lake Jackson, TX (US)

(21) Appl. No.: 17/635,715

(22) PCT Filed: Aug. 24, 2020
(86) PCT No.: PCT/US2020/047612

§ 371 Date: Feb. 16, 2022

Related U.S. Application Data
(60) Provisional application No. 62/892,607, filed on Aug. 28, 2019.

(51) Int. Cl. C08L 33/08; C08L 23/08; C09D 123/08; C09D 133/08; H01B 3/44

(52) U.S. Cl. CPC C08L 33/08; C08L 23/0869; C08L 23/0853; C08L 23/0846; C09D 123/0853; C09D 133/08; H01B 3/446; C08L 2203/206; C08L 2203/202; H01B 7/17

(57) ABSTRACT

A polyethylene copolymer blend consisting essentially of (A) an ethylene/unsaturated carboxylic ester bipolymer and (B) an ethylene/unsaturated carboxylic ester/carbon monoxide terpolymer. The polyethylene copolymer blend is defined by constituents (A) and (B) and at least one omitted material that would have otherwise restricted a physical property of the blend. The (A) ethylene/unsaturated carboxylic ester bipolymer is defined by features comprising choice of unsaturated carboxylic ester, unsaturated carboxylic ester comonomeric content in weight percent (wt %), and bipolymer melt index (I₂; 190° C., 2.16 kg) in grams per 10 minutes (g/10 min.). The (B) ethylene/unsaturated carboxylic ester/carbon monoxide terpolymer is defined by features comprising choice of unsaturated carboxylic ester, unsaturated carboxylic ester comonomeric content in wt %, carbon monoxide comonomeric content in wt %, and terpolymer melt index (I₂; 190° C., 2.16 kg) in g/10 min. Also formulations, cured polymer products, strippable semiconductive insulation shield layers, coated conductors, methods of making and using same.

### FIELD

Polyethylene copolymer blend, formulation, and related aspects.

### INTRODUCTION

Patents and patent application publications in or about the field include U.S. Pat. Nos. 6,133,367; 6,316,120 B1; US 2006/0142458 A1; and US 2012/0031641 A1.

The U.S. Pat. No. 6,133,367 patent issued to Richard James Arhart (“Arhart”). Arhart relates to blends of copolymers having a certain percentage of vinyl acetate monomer with a terpolymer having a certain percentage of vinyl acetate wherein the composition provides heat and flame resistant properties to wires and cable or other manufactured goods prepared from such compositions (Abstract). Arhart's blends are prepared by combining the ingredients with other excipients selected from aluminum trihydrate, carbon black, stearic acid, tri(2-methoxyethoxy) vinyl silane, polymeric hindered phenol, dilaurylthipropionate, N,N′-m-phenylenedimalemide; and α,α′-bis (t-butylperoxy) diisopropylbenzene (a primary crosslinking agent) (Abstract). The blend comprises constituents (a) and (b) and the excipients (col. 2, lines 9-41). The blend is useful in various applications, including among things, providing strippability for semiconductive shields for power cable (col. 2, lines 47-65).

Thus, Arhart's curable composition requires the combination of the mineral filler and the tri(2-methoxyethoxy) vinyl silane for heat and flame resistance and enhanced physical properties. Arhart's cured composition requires the reaction product of a reaction of constituent (a) and/or (b) and the mineral filler with the tri(2-methoxyethoxy) vinyl silane for heat and flame resistance and enhanced physical properties. Arhart's physical properties are mentioned in Tables 2 and 4 to 6. All other things being equal, the aluminum trihydrate decreases percent elongation, and increases Shore A hardness, Tensile strength, modulus, melt index (I₂), percent LOI (limiting oxygen index), and low temperature brittleness of Arhart's composition.

### SUMMARY

A typical coated conductor sequentially comprises (starting from an innermost component on outward toward an outermost component) a conductive core, a semiconductive shield layer, an insulation layer, a strippable semiconductive insulation shield layer, and an outer sheath. For joining (e.g., via splicing) the coated conductor to another coated conductor or to an electrical component, the strippable semiconductive insulation shield layer is required to be easily and cleanly stripped from the insulation layer without removing the insulation layer. We discovered a need for a coated conductor, such as a wire or cable, that has a layer with increased strippability but without the restriction placed on physical properties derived from use of a combination of a mineral filler and an olefin-functional hydrolyzable silane. For example, without increasing low temperature brittleness, which would harm performance of cables.

We discovered such a polyethylene copolymer blend consisting essentially of (A) an ethylene/unsaturated carboxylic ester bipolymer and (B) an ethylene/unsaturated carboxylic ester/carbon monoxide terpolymer. The polyethylene copolymer blend is defined by constituents (A) and (B) and at least one omitted material that would have otherwise restricted a physical property of the blend. The (A) ethylene/unsaturated carboxylic ester bipolymer is defined by features comprising choice of unsaturated carboxylic ester, unsaturated carboxylic ester comonomeric content in weight percent (wt %), and bipolymer melt index (I₂; 190° C., 2.16 kg) in grams per 10 minutes (g/10 min.). The (B) ethylene/unsaturated carboxylic ester/carbon monoxide terpolymer is defined by features comprising choice of unsaturated carboxylic ester, unsaturated carboxylic ester comonomeric content in wt %, carbon monoxide comonomeric content in wt %, and terpolymer melt index (I₂; 190° C., 2.16 kg) in g/10 min.

Also discovered is a curable formulation consists essentially of the polyethylene copolymer blend and at least one additive that is not a mineral filler and/or an olefin-functional hydrolyzable silane. For simplicity herein, the “additive that is not a mineral filler and/or an olefin-functional hydrolyzable silane” is shortened to “the featured additive”.

Also discovered is a cured product made by curing the curable formulation. Before curing, the at least one featured additive of the curable formulation may include an organic peroxide.

Also discovered is a strippable semiconductive insulation shield layer of a coated conductor in need thereof, such as a wire or cable in need thereof. The strippable semiconductive insulation shield layer consists essentially of an embodiment of the cured product made by curing an embodiment of the curable formulation wherein the at least one featured additive of the curable formulation consists essentially of an organic peroxide, a carbon black, an antioxidant, and, optionally, 0, 1 or more of a processing aid (slip additive) and a stabilizer that is effective against degrading effects of ultraviolet light.

Also discovered is a coated conductor sequentially (starting from an innermost component on outward toward an outermost component) consisting essentially of a conductive core, a semiconductive shield layer, an insulation layer, the strippable semiconductive insulation shield layer, and, optionally, an outer sheath.

The related aspects also include methods of making and using same.

### DETAILED DESCRIPTION

The polyethylene copolymer blend consisting essentially of (A) an ethylene/unsaturated carboxylic ester bipolymer and (B) an ethylene/unsaturated carboxylic ester/carbon monoxide terpolymer. The (A) ethylene/unsaturated carboxylic ester bipolymer is defined by features comprising choice of unsaturated carboxylic ester, unsaturated carboxylic ester comonomeric content in weight percent (wt %), and bipolymer melt index (I₂; 190° C., 2.16 kg) in grams per 10 minutes (g/10 min.). The (B) ethylene/unsaturated carboxylic ester/carbon monoxide terpolymer is defined by features comprising choice of unsaturated carboxylic ester, unsaturated carboxylic ester comonomeric content in wt %, carbon monoxide comonomeric content in wt %, and terpolymer melt index (I₂; 190° C., 2.16 kg) in g/10 min.

The curable formulation consists essentially of the polyethylene copolymer blend and at least one additive that is not a mineral filler and/or an olefin-functional hydrolyzable silane (“the featured additive”).

The cured product is made by curing the curable formulation. Before curing, the at least one featured additive of the curable formulation may include an organic peroxide.

The strippable semiconductive insulation shield layer of a coated conductor in need thereof, such as a wire or cable in need thereof. The strippable semiconductive insulation shield layer consists essentially of an embodiment of the cured product made by curing an embodiment of the curable formulation wherein the at least one featured additive of the curable formulation consists essentially of an organic peroxide, a carbon black, an antioxidant, and, optionally, 0, 1 or more of a processing aid (slip additive) and a stabilizer that is effective against degrading effects of ultraviolet light.

The coated conductor sequentially (starting from an innermost component on outward toward an outermost component) consisting essentially of a conductive core (e.g., a copper wire or bundle of copper wires), a semiconductive shield layer, an insulation layer, the strippable semiconductive insulation shield layer, and, optionally, an outer sheath (anti-weathering layer).

The related aspects also include methods of making and using same.

Bipolymer means a macromolecule having different types of constituent units consisting essentially of one type of monomeric units (e.g., ethylenic units) and one type of comonomeric units (e.g., unsaturated carboxylic ester comonomeric units), which are structurally different than the monomeric units. The bipolymer may be made by a polymerization process that does not include an olefin chain transfer agent, alternatively by a polymerization process that includes a de minimus amount of an olefin chain transfer agent (e.g., propene). When the bipolymer is made by a polymerization process that does not include the olefin chain transfer agent, the constituent units consist of the one type of monomeric units (e.g., ethylenic units) and the one type of comonomeric units (e.g., unsaturated carboxylic ester comonomeric units), which are structurally different than the monomeric units. When the bipolymer is made by a polymerization process that includes the de minimus amount of the olefin chain transfer agent, the constituent units consist of the one type of monomeric units (e.g., ethylenic units), the one type of comonomeric units (e.g., unsaturated carboxylic ester comonomeric units), and from >0 to 2.0 wt %, alternatively from 0.1 to 1.0 wt %, of olefinic units (e.g., propylenic units) derived from the olefin chain transfer agent. The bipolymer is free of any other type of constituent units such as carbon monoxide comonomeric units or grafted units.

Blend means a mixture of at least two substances characterized by a random distribution of one substance throughout another substance without a chemical reaction or covalent bond forming between the substances. The inventive blend is free of a nitrile rubber (NR) such as a nitrile butadiene rubber (NBR).

Carbon monoxide means a compound of molecular formula CO and structure: C≡O:.

Comonomer content of the unsaturated carboxylic ester is the weight of comonomeric units derived from the unsaturated carboxylic ester as a percentage of the total weight of the bipolymer or terpolymer, as the case may be.

Comonomer content of the carbon monoxide is the weight of comonomeric units derived from the carbon monoxide as a percentage of the total weight of the terpolymer.

Comprises and comprising and similar open-ended terms (e.g., contains, containing, has, and having) with respect to the constituent compound, feature, element, step, or property with which they are being used and modifying with the proviso that their use does not eliminate, negate, remove, or overcome the below-described limitations imposed by the partially closed expressions consisting essentially of or consists essentially of.

Consisting essentially of and consists essentially of mean that when both the constituent (A) is an ethylene/vinyl acetate (EVA) copolymer and the constituent (B) is an ethylene/vinyl acetate/carbon monoxide (EVACO) terpolymer, the inventive polyethylene copolymer blend, curable formulation, cured product, strippable semiconductive insulation shield layer, the strippable semiconductive insulation shield layer of the coated conductor, and the methods are free of at least one of, alternatively any two of, alternatively each of materials (i) to (iii) and, optionally material (iv): (i) a mineral filler, (ii) an olefin-functional hydrolyzable silane, and (iii) a reaction product of a reaction of a reactant with the mineral filler and/or the olefin-functional hydrolyzable silane; and, optionally (iv) a nitrile butadiene rubber (NBR). Collectively the at least one material (i) to (iii) and, optionally, material (iv) are the “omitted material(s)”. In some aspects the omitted material(s) are materials (i) and (ii); alternatively (i) and (iii); alternatively (ii) and (iii); alternatively (i) to (iii); alternatively (i), (ii), and (iv); alternatively (i), (iii), and (iv); alternatively (ii), (iii), and (iv); alternatively (i) to (iv). In other embodiments when one, but not both, of the constituent (A) is an ethylene/vinyl acetate (EVA) copolymer and the constituent (B) is an ethylene/vinyl acetate/carbon monoxide (EVACO) terpolymer, the inventive polyethylene copolymer blend, curable formulation, cured product, strippable semiconductive insulation shield layer, the strippable semiconductive insulation shield layer of the coated conductor, and the methods are free of the material(s). In still other embodiments, for each constituent (A) and constituent (B), the inventive polyethylene copolymer blend, curable formulation, cured product, strippable semiconductive insulation shield layer, the strippable semiconductive insulation shield layer of the coated conductor, and the methods are free of the omitted material(s).

Free of means lacks or absence of. Any embodiment that is free of the omitted material(s) is, thus, without the restriction on at least one physical property that otherwise would be restricted by the omitted material(s). The at least one physical property is selected from percent elongation, Shore A hardness, Tensile strength, modulus, melt index (I₂), percent LOI (limiting oxygen index), and low temperature brittleness. Percent elongation is not decreased by the omitted material(s); and/or at least one of Shore A hardness, Tensile strength, modulus, melt index (I₂), percent LOI (limiting oxygen index), and low temperature brittleness is not increased by the omitted material(s).

Terpolymer means a macromolecule having different types of constituent units consisting essentially of one type of monomeric units (e.g., ethylenic units) and two different types of comonomeric units consisting of first comonomeric units (e.g., unsaturated carboxylic ester comonomeric units) and second comonomeric units (e.g., carbon monoxide comonomeric units), wherein the monomeric units and the first and second comonomeric units are structurally different than each other. The terpolymer may be made by a polymerization process that does not include an olefin chain transfer agent, alternatively by a polymerization process that includes a de minimus amount of an olefin chain transfer agent (e.g., propene). When the terpolymer is made by a polymerization process that does not include the olefin chain transfer agent, the constituent units consist of the one type of monomeric units (e.g., ethylenic units) and the two different types of comonomeric units consisting of first comonomeric units (e.g., unsaturated carboxylic ester comonomeric units) and second comonomeric units (e.g., carbon monoxide comonomeric units), wherein the monomeric units and the first and second comonomeric units are structurally different than each other. When the terpolymer is made by a polymerization process that includes the de minimus amount of the olefin chain transfer agent, the constituent units consist of the one type of monomeric units (e.g., ethylenic units), the two different types of comonomeric units consisting of first comonomeric units (e.g., unsaturated carboxylic ester comonomeric units) and second comonomeric units (e.g., carbon monoxide comonomeric units), and from >0 to 2.0 wt %, alternatively from 0.1 to 1.0 wt %, of olefinic units (e.g., propylenic units) derived from the olefin chain transfer agent. The terpolymer is free of any other type of constituent units such as styrenic comonomeric units and grafted units.

Unsaturated carboxylic ester means a compound of formula (I) R¹—C(═O)—O—R² (I), wherein one of R¹ and R² is a H₂C═C(R)—(CH₂)ₘ— and the other of R¹ and R² is a (C₁-C₈)alkyl; wherein subscript m is an integer from 0 to 8 and R is H or methyl; or the unsaturated carboxylic ester is a di(C₁-C₈)alkyl diester of an unsaturated (C₄-C₈)dicarboxylic ester.

In some aspects of the formula (I), subscript m is 0. In some aspects R¹ is a H₂C═C(R)—(CH₂)ₘ— and R² is a (C₁-C₈)alkyl; alternatively R¹ is a (C₁-C₈)alkyl and R² is a —(CH₂)ₘ)—C(R)═CH₂. In some aspects the unsaturated carboxylic ester is vinyl acetate, a (C₁-C₈)alkyl acrylate, or a (C₁-C₈)alkyl methacrylate; alternatively the unsaturated carboxylic ester is vinyl acetate or a (C₁-C₈)alkyl acrylate; alternatively the unsaturated carboxylic ester is vinyl acetate or a (C₁-C₄)alkyl acrylate; alternatively the unsaturated carboxylic ester is vinyl acetate or a (C₂-C₄)alkyl acrylate; alternatively the unsaturated carboxylic ester is vinyl acetate, methyl acrylate, ethyl acrylate, or butyl acrylate; alternatively the unsaturated carboxylic ester is vinyl acetate, ethyl acrylate, or butyl acrylate; alternatively the unsaturated carboxylic ester is vinyl acetate, alternatively methyl acrylate, alternatively ethyl acrylate; alternatively butyl acrylate, alternatively ethyl methacrylate; alternatively butyl methacrylate. Vinyl acetate is a compound of formula (I) wherein subscript m is 0, R is H, R¹ is H₃C—, and R² is —C(H)═CH₂. Ethyl acrylate is a compound of formula (I) wherein subscript m is 0, R is H, R¹ is H₂C═C(H)— and R² is —CH₂CH₃. Butyl acrylate is a compound of formula (I) wherein subscript m is 0, R is H, R¹ is H₂C═C(H)— and R² is —CH₂CH₂CH₂CH₃. Ethyl methacrylate is a compound of formula (I) wherein subscript m is 0, R is methyl, R¹ is H₂C═C(CH₃)— and R² is —CH₂CH₃. Butyl methacrylate is a compound of formula (I) wherein subscript m is 0, R is methyl, R¹ is H₂C═C(CH₃)— and R² is —CH₂CH₂CH₂CH₃.

Some embodiments are numbered for ease of reference.

Aspect 1. A polyethylene copolymer blend consisting essentially of from 46 to 85 wt % of (A) an ethylene/unsaturated carboxylic ester bipolymer (“constituent (A)”) and from 54 to 15 wt % of (B) an ethylene/unsaturated carboxylic ester/carbon monoxide terpolymer (“constituent (B)”), based on the total weight of (A) and (B); wherein the (A) ethylene/unsaturated carboxylic ester bipolymer is an ethylene/vinyl acetate (EVA) bipolymer or ethylene/ethyl acrylate (EEA) bipolymer and the bipolymer has an unsaturated carboxylic ester comonomeric content from 18 to 33 wt % and a melt index (I₂; 190° C., 2.16 kg) from 5 to 35 g/10 min.; and wherein the (B) ethylene/unsaturated carboxylic ester/carbon monoxide terpolymer is an ethylene/vinyl acetate/carbon monoxide (EVACO) terpolymer or an ethylene/butyl acrylate/carbon monoxide (EBACO) terpolymer and the terpolymer has unsaturated carboxylic ester comonomeric content from 19 to 32 wt %, carbon monoxide comonomeric content from 7 to 11 wt %, and a melt index (I₂; 190° C., 2.16 kg) from 6 to 39 g/10 min.

Aspect 2. The polyethylene copolymer blend of aspect 1 of any one of features (a) to (d): (a) wherein constituent (A) is the ethylene/vinyl acetate (EVA) bipolymer and constituent (B) is the ethylene/vinyl acetate/carbon monoxide (EVACO) terpolymer and the polyethylene copolymer blend is free of at least one of, alternatively any two of, alternatively each of materials (i) to (iii); (b) wherein constituent (A) is an EVA bipolymer and constituent (B) is the ethylene/butyl acrylate/carbon monoxide (EBACO) terpolymer; (c) wherein constituent (A) is the ethylene/ethyl acrylate (EEA) bipolymer and constituent (B) is the EVACO terpolymer; (b) wherein constituent (A) is the EEA bipolymer and constituent (B) is the EBACO terpolymer; and (e) any one of features (b) to (d) wherein the polyethylene copolymer blend is free of at least one of, alternatively any two of, alternatively each of materials (i) to (iii) and, optionally material (iv). In some aspects the omitted material(s) is any one of the combinations thereof described earlier.

Aspect 3. The polyethylene copolymer blend of aspect 1 or 2 consisting essentially of from 46 to 85 wt % (e.g., 83 wt %, 75 wt %, 50 wt %, 83 wt %, 83 wt %, 77 wt %, 83 wt %, or 50 wt %) of the (A) ethylene/unsaturated carboxylic ester bipolymer and from 54 to 15 wt % (e.g., 17 wt %, 25 wt %, 50 wt %, 17 wt %, 17 wt %, 23 wt %, 17 wt %, or 50 wt %, respectively) of the (B) ethylene/unsaturated carboxylic ester/carbon monoxide terpolymer, based on the total weight of (A) and (B); wherein the (A) ethylene/unsaturated carboxylic ester bipolymer is an ethylene/vinyl acetate (EVA) bipolymer that has an unsaturated carboxylic ester comonomeric content from 27 to 33 wt % (e.g., 32 wt %) and a melt index (I₂; 190° C., 2.16 kg) from 25 to 35 g/10 min. (e.g., 30 g/10 min.) or the (A) ethylene/unsaturated carboxylic ester bipolymer is an ethylene/ethyl acrylate (EEA) bipolymer that has an unsaturated carboxylic ester comonomeric content from 15 to 21 wt % (e.g., 18 wt %) and a melt index (I₂; 190° C., 2.16 kg) from 5 to 9 g/10 min. (e.g., 6 g/10 min.); and wherein the (B) ethylene/unsaturated carboxylic ester/carbon monoxide terpolymer is an ethylene/vinyl acetate/carbon monoxide (EVACO) terpolymer that has unsaturated carboxylic ester comonomeric content from 19 to 25 wt %, alternatively from 19 to 23 wt % (e.g., 24 wt % or 20.5 wt %), carbon monoxide comonomeric content from 7 to 11 wt % (e.g., 10 wt % or 8 wt %, respectively), and a melt index (I₂; 190° C., 2.16 kg) from 14 to 36 g/10 min. (e.g., 35 or 15 g/10 min., respectively) or the (B) ethylene/unsaturated carboxylic ester/carbon monoxide terpolymer is an ethylene/butyl acrylate/carbon monoxide (EBACO) terpolymer that has an unsaturated carboxylic ester comonomeric content from 25 to 32 wt % (e.g., 30 wt % or 30 wt %, respectively), carbon monoxide comonomeric content from 9 to 11 wt % (e.g., 10 wt % or 10 wt %, respectively), and a melt index (I₂; 190° C., 2.16 kg) from 6 to 15 g/10 min. (e.g., 8 g/10 min. or 12 g/10 min., respectively).

Aspect 4. The polyethylene copolymer blend of aspect 3 selected from any one of polyethylene copolymer blends (1) to (8): (1) 83 wt % of constituent (A) that is an EVA bipolymer having 32 wt % vinyl acetate comonomeric content and a melt index (I₂) of 30 g/10 min. and 17 wt % of constituent (B) that is an EVACO terpolymer having 20 to 21 wt % vinyl acetate comonomeric content and 8 wt % carbon monoxide comonomeric content and a melt index (I₂) of 15 g/10 min.; (2) 75 wt % of constituent (A) that is an EVA bipolymer having 32 wt % vinyl acetate comonomeric content and a melt index (I₂) of 30 g/10 min. and 25 wt % of constituent (B) that is an EVACO terpolymer having 20 to 21 wt % vinyl acetate comonomeric content and 8 wt % carbon monoxide comonomeric content and a melt index (I₂) of 15 g/10 min.; (3) 50 wt % of constituent (A) that is an EVA bipolymer having 32 wt % vinyl acetate comonomeric content and a melt index (I₂) of 30 g/10 min. and 50 wt % of constituent (B) that is an EVACO terpolymer having 20 to 21 wt % vinyl acetate comonomeric content and 8 wt % carbon monoxide comonomeric content and a melt index (I₂) of 15 g/10 min.; (4) 83 wt % of constituent (A) that is an EVA bipolymer having 32 wt % vinyl acetate comonomeric content and a melt index (I₂) of 30 g/10 min. and 17 wt % of constituent (B) that is an EBACO terpolymer having 30 wt % butyl acrylate comonomeric content and 10 wt % carbon monoxide comonomeric content and a melt index (I₂) of 8 g/10 min.; (5) 83 wt % of constituent (A) that is an EVA bipolymer having 32 wt % vinyl acetate comonomeric content and a melt index (I₂) of 30 g/10 min. and 17 wt % of constituent (B) that is an EBACO terpolymer having 30 wt % butyl acrylate comonomeric content and 10 wt % carbon monoxide comonomeric content and a melt index (I₂) of 12 g/10 min.; (6) 77 wt % of constituent (A) that is an EVA bipolymer having 32 wt % vinyl acetate comonomeric content and a melt index (I₂) of 30 g/10 min. and 23 wt % of constituent (B) that is an EVACO terpolymer having 20 to 21 wt % vinyl acetate comonomeric content and 8 wt % carbon monoxide comonomeric content and a melt index (I₂) of 15 g/10 min.; (7) 83.2 wt % of constituent (A) that is an ethylene/ethyl acrylate (EEA) bipolymer having 18 wt % ethyl acrylate comonomeric content and a melt index (I₂) of 6 g/10 min. and 16.8 wt % of constituent (B) that is an EBACO terpolymer having 30 wt % butyl acrylate comonomeric content and 10 wt % carbon monoxide comonomeric content and a melt index (I₂) of 8 g/10 min.; and (8) 50 wt % of constituent (A) that is an ethylene/ethyl acrylate (EEA) bipolymer having 18 wt % ethyl acrylate comonomeric content and a melt index (I₂) of 6 g/10 min. and 50 wt % of constituent (B) that is an EBACO terpolymer having 30 wt % butyl acrylate comonomeric content and 10 wt % carbon monoxide comonomeric content and a melt index (I₂) of 8 g/10 min. In some aspects the group from which the polyethylene copolymer blend is selected from is seven of blends (1) to (8).

Aspect 5. A curable formulation consisting essentially of the polyethylene copolymer blend of any one of aspects 1 to 4 and at least one additive that is not a mineral filler and/or an olefin-functional hydrolyzable silane (“the featured additive”) selected from the group consisting of additives (C) to (1): (C) an antioxidant; (D) a carbon black; (E) an organic peroxide; (F) a stabilizer for stabilizing the formulation against effects of ultraviolet light (UV stabilizer), such as a hindered amine light stabilizer (HALS); (G) a processing aid; (H) any four of additives (C) to (G); and (1) each of additives (C) to (G).

Aspect 6. The curable formulation of aspect 5 wherein the at least one featured additive includes the (C) antioxidant and (D) carbon black; and optionally includes the (E) organic peroxide; optionally the (F) stabilizer for stabilizing the formulation against effects of ultraviolet light (UV stabilizer); and optionally the (G) processing aid. In some aspects (E) is included.

Aspect 7. A method of making a curable formulation of any one of aspects 5 to 6, the method consisting essentially of mixing a melt of (A) ethylene/unsaturated carboxylic ester and (B) ethylene/unsaturated carboxylic ester/carbon monoxide terpolymer and the at least one featured additive, so as to give a melt-mixture consisting essentially of the melt of (A) and (B) and the at least one featured additive; and extruding the melt-mixture so as to make the curable formulation.

Aspect 8. A method of making a cured polymer product, the method consisting essentially of curing (irradiating or heating with (E) organic peroxide) the curable formulation of aspect 5 or 6 so as to give the cured polymer product.

Aspect 9. A cured polymer product made by the method of aspect 8. Examples are a coating on a substrate, a tape, a film, a layer of a laminate, a foam, and a pipe.

Aspect 10. A strippable semiconductive insulation shield layer consisting essentially of a shaped form of a cured polymer product made by curing with (E) organic peroxide the curable formulation of aspect 6.

Aspect 11. A coated conductor sequentially (starting from an innermost component on outward toward an outermost component) consisting essentially of a conductive core (e.g., a copper wire or bundle of copper wires), a semiconductive shield layer, an insulation layer, the strippable semiconductive insulation shield layer made of the cured polymer product of aspect 10, and, optionally, an outer sheath (anti-weathering layer such as a metal sheath or sleeve). The conductive core may be linear shape (e.g., like a wire) having a length and proximal and distal ends spaced apart from each other by the length of the linear shape; and the polymeric layer may surround the conductive core except for the proximal and distal ends. The insulation layer is free of a conductive filler (e.g., carbon black), whereas the strippable semiconductive insulation shield layer contains a semiconducting-effective amount of a conductive filler (e.g., carbon black). The coated conductor may further consist essentially of one or more additional polymeric layers, which independently may or may not include the cured polymer product.

Aspect 12. A method of conducting electricity, the method consisting essentially of applying a voltage across the conductive core of the coated conductor of aspect 11 so as to generate a flow of electricity through the conductive core. The conductive core may have length and proximal and distal ends spaced apart by the length, and the electricity may flow the length of the conductive core from the proximal end to the distal end, or vice versa.

Aspect 13. An insulation laminate consisting essentially of an insulation layer and an strippable insulation shield layer, which is in direct physical contact with the insulation layer; wherein the insulation layer comprises a cured polyethylene that is free of carbon black and wherein the strippable insulation shield layer consists essentially of a cured product of curing a curable formulation consisting essentially of the polyethylene copolymer blend of any one of aspects 1 to 4; (C) an antioxidant; (D) a carbon black; and (E) an organic peroxide. The amount of the (D) carbon black in the strippable insulation shield layer may be less than a semiconducting effective amount (e.g., from 1 to 30 wt % based on total weight of the strippable insulation shield layer), alternatively may be a semiconducting effective amount (e.g., from 30 to 50 wt %, alternatively from 33 to 39 wt %, based on total weight of the strippable insulation shield layer).

As indicated by the “consisting essentially of” or “consists essentially of” in aspects 1 to 12, the polyethylene copolymer blend, curable formulation, cured product, strippable semiconductive insulation shield layer, the strippable semiconductive insulation shield layer of the coated conductor, and methods are free of at least one of, alternatively any two of, alternatively each of materials (i) to (iii) and, optionally, material (iv): (i) a mineral filler, (ii) an olefin-functional hydrolyzable silane, and (iii) a reaction product of a reaction of a reactant with the mineral filler and/or the olefin-functional hydrolyzable silane; and, optionally, (iv) a nitrile butadiene rubber (NBR) (collectively the “omitted material(s)”). In some aspects the omitted material(s) are materials (i) and (ii); alternatively (i) and (iii); alternatively (ii) and (iii); alternatively (i) to (iii); alternatively (i), (ii), and (iv); alternatively (i), (iii), and (iv); alternatively (ii), (iii), and (iv); alternatively (i) to (iv).

The total weight of all constituents, including featured additives, in the curable formulation is 100.00 wt %.

The curable formulation may be made according to the above method or the method exemplified later in the Examples. The formulation may be made in a continuous (monolithic) or divided solid form. The formulation may be extruded, pelletized, and/or shaped so as to give formulation as a solid (e.g., shaped or pellets).

The curable formulation may be made as a one-part formulation, alternatively a multi-part formulation such as a two-part formulation. The two-part formulation may comprise first and second parts, wherein the first part consists essentially of the (hydrolyzable silyl group)-functional polyethylene copolymer and optionally any one or more of additives (C) to (I); and the second part consists essentially of the (B) condensation cure catalyst or catalyst masterbatch comprising a carrier resin (as an example of the (I) polymer that is not (A)) and (B), and an optional additional portion of (A) HSG-FP Copolymer and optionally any one or more of additives (C) to (I).

The inventive aspects (blend, formulation, product, layer, article, method) may be free of water (anhydrous). The constituents (A) and (B), alternatively the inventive blend, formulation, product, layer, and article may be free of post-copolymerization reactor modification (e.g., free of a post-reactor grafted functional group).

The (A) ethylene/unsaturated carboxylic ester bipolymer may be an ethylene/vinyl acetate (EVA) bipolymer or an ethylene/ethyl acrylate (EEA) bipolymer as described earlier. The constituent (A) is a macromolecule, or a collection thereof, that is/are a reactor copolymer of ethylene (monomer) and at least one unsaturated carboxylic ester comonomer. The (A) is a random copolymer having 67 to 82 wt % ethylenic constituent units, as the case may be based on the aforementioned unsaturated carboxylic ester comonomeric content. In some aspects constituent (A) may further have from 0 to 2 wt % propylenic constituent units derived from propylene. The (A) may be free of silicon-containing groups. In any one of aspects 1 to 4, the constituent (A) may be selected from inventive examples (A)1 and (A)2 described later.

The (B) ethylene/unsaturated carboxylic ester/carbon monoxide terpolymer may be an ethylene/vinyl acetate/carbon monoxide (EVACO) terpolymer or an ethylene/butyl acrylate/carbon monoxide (EBACO) terpolymer as described earlier. The constituent (B) is a macromolecule, or a collection thereof, that is/are a reactor-copolymer of ethylene (monomer), at least one unsaturated carboxylic ester comonomer, and carbon dioxide comonomer. The (B) is a random copolymer having 54 to 74 wt % ethylenic constituent units, as the case may be based on the aforementioned unsaturated carboxylic ester comonomeric and carbon dioxide comonomeric contents. In some aspects constituent (B) may further have from 0 to 2 wt % propylenic constituent units derived from propylene. The (B) may be free of silicon-containing groups. In any one of aspects 1 to 4, the constituent (B) may be selected from the inventive examples (B)1, (B)2, (B)3, and (B)4 described later; alternatively from (B)1, (B)2, and (B)3; alternatively from any two of (B)1, (B)2, and (B)3.

In some embodiments the constituent (A) may be selected from inventive examples (A)1 and (A)2; and the constituent (B) may be selected from the inventive examples (B)1, (B)2, and (B)3, alternatively from any two of (B)1, (B)2, and (B)3, alternatively from (B)1, alternatively from (B)2, alternatively from (B)3. In some such embodiments the constituent (A) is (A)1, alternatively (A)2.

Optional additive (C) an antioxidant: an organic molecule that inhibits oxidation, or a collection of such molecules. The (C) antioxidant is different in composition than the (F) stabilizer, which means when the formulation contains both (C) and (F), the compound used as (C) is different than that used as (F). The (C) antioxidant functions to provide antioxidizing properties to the curable formulation and/or cured polymer product. Examples of suitable (C) are bis(4-(1-methyl-1-phenylethyl)phenyl)amine (e.g., NAUGARD 445); 2,2′-methylene-bis(4-methyl-6-t-butylphenol) (e.g., VANOX MBPC); 2,2′-thiobis(2-t-butyl-5-methylphenol (CAS No. 90-66-4; 4,4′-thiobis(2-t-butyl-5-methylphenol) (also known as 4,4′-thiobis(6-tert-butyl-m-cresol), CAS No. 96-69-5, commercially LOWINOX TBM-6); 2,2′-thiobis(6-t-butyl-4-methylphenol (CAS No. 90-66-4, commercially LOWINOX TBP-6); tris[(4-tert-butyl-3-hydroxy-2,6-dimethylphenyl)methyl]-1,3,5-triazine-2,4,6-trione (e.g., CYANOX 1790); pentaerythritol tetrakis(3-(3,5-bis(1,1-dimethylethyl)-4-hydroxyphenyl)propionate (e.g., IRGANOX 1010, CAS Number 6683-19-8); 3,5-bis(1,1-dimethylethyl)-4-hydroxybenzenepropanoic acid 2,2′-thiodiethanediyl ester (e.g., IRGANOX 1035, CAS Number 41484-35-9); distearyl thiodipropionate (“DSTDP”); dilauryl thiodipropionate (e.g., IRGANOX PS 800): stearyl 3-(3,5-di-t-butyl-4-hydroxyphenyl)propionate (e.g., IRGANOX 1076); 2,4-bis(dodecylthiomethyl)-6-methylphenol (IRGANOX 1726); 4,6-bis(octylthiomethyl)-o-cresol (e.g. IRGANOX 1520); and 2′,3-bis[[3-[3,5-di-tert-butyl-4-hydroxyphenyl]propionyl]] propionohydrazide (IRGANOX 1024). The (C) may be 4,4′-thiobis(2-t-butyl-5-methyphenol) (also known as 4,4′-thiobis(6-tert-butyl-m-cresol); 2,2′-thiobis(6-t-butyl-4-methylphenol; tris[(4-tert-butyl-3-hydroxy-2,6-dimethylphenyl)methyl]-1,3,5-triazine-2,4,6-trione; distearyl thiodipropionate; or dilauryl thiodipropionate; or a combination of any two or more thereof. The combination may be tris[(4-tert-butyl-3-hydroxy-2,6-dimethylphenyl)methyl]-1,3,5-triazine-2,4,6-trione and distearyl thiodipropionate. The formulation and/or cured polymer product may be free of (C). When present, the (C) antioxidant may be from 0.01 to 1.5 wt %, alternatively 0.1 to 1.0 wt % of the total weight of the formulation and/or product.

Optional additive (D) a carbon black. The carbon black may be provided as a carbon black masterbatch that is a formulation of poly(l-butene-co-ethylene) copolymer (from 95 wt % to <100 wt % of the total weight of the masterbatch) and carbon black (from >0 wt % to 5 wt % of the total weight of the masterbatch. Carbon black is a finely-divided form of paracrystalline carbon having a high surface area-to-volume ratio, but lower than that of activated carbon. Examples of carbon black are furnace carbon black, acetylene carbon black, conductive carbons (e.g., carbon fibers, carbon nanotubes, graphene, graphite, and expanded graphite platelets). The curable formulation and/or cured polymer product may be free of (D). When present (D) may be from 0.1 to 45 wt %, alternatively 33 to 37 wt % of the formulation.

Optional additive (E): organic peroxide: a compound containing one or two C—O—O—C groups and lacking —O—O—H. A (E) organic monoperoxide is of formula R^{O}—O—O—R^{O}, wherein each R^{O} independently is a (C₁-C₂₀)alkyl group or (C₆-C₂₀)aryl group. Each (C₁-C₂₀)alkyl group independently is unsubstituted or substituted with 1 or 2 (C₆-C₁₂)aryl groups. Each (C₆-C₂₀)aryl group is unsubstituted or substituted with 1 to 4 (C₁-C₁₀)alkyl groups. A (E) organic diperoxide is of formula R^{O}—O—O—R—O—O—R^{O}, wherein R is a divalent hydrocarbon group such as a (C₂-C₁₀)alkylene, (C₃-C₁₀)cycloalkylene, or phenylene, and each R^{O} is as defined above. The (E) organic peroxide may be bis(1,1-dimethylethyl) peroxide; bis(1,1-dimethylpropyl) peroxide; 2,5-dimethyl-2,5-bis(1,1-dimethylethylperoxy) hexane; 2,5-dimethyl-2,5-bis(1,1-dimethylethylperoxy) hexyne; 4,4-bis(1,1-dimethylethylperoxy) valeric acid; butyl ester; 1,1-bis(1,1-dimethylethylperoxy)-3,3,5-trimethylcyclohexane; benzoyl peroxide; tert-butyl peroxybenzoate; di-tert-amyl peroxide (“DTAP”); bis(alpha-t-butyl-peroxyisopropyl) benzene (“BIPB”); isopropylcumyl t-butyl peroxide; t-butylcumylperoxide; di-t-butyl peroxide; 2,5-bis(t-butylperoxy)-2,5-dimethylhexane; 2,5-bis(t-butylperoxy)-2,5-dimethylhexyne-3,1,1-bis(t-butylperoxy)-3,3,5-trimethylcyclohexane; isopropylcumyl cumylperoxide; butyl 4,4-di(tert-butylperoxy) valerate; or di(isopropylcumyl) peroxide; or dicumyl peroxide. The (E) organic peroxide may be bis(t-butyl peroxy isopropyl)benzene (e.g., LUPEROX D446B). The (E) organic peroxide may be dicumyl peroxide. A blend of two or more (E) organic peroxides may be used, e.g., a 20:80 (wt/wt) blend of t-butyl cumyl peroxide and bis(t-butyl peroxy isopropyl)benzene (e.g., LUPEROX D446B, which is commercially available from Arkema). In some aspects at least one, alternatively each (E) organic peroxide contains one —O—O— group. In some aspects the polyolefin-and-poly(2-alkyl-2-oxazoline) formulation and crosslinked polyolefin product is free of (E). When present, the inventive formulation contains at least one (E) organic peroxide, and the total amount of the (E) organic peroxide(s) may be 0.05 to 3 wt %, alternatively 0.1 to 3.0 wt %, alternatively 0.5 to 2.5 wt %, alternatively 1.0 to 2.0 wt % of the inventive formulation. The weight/weight ratio of (C) antioxidant to all (E) organic peroxide, if any, is from >0 to less than 2 ((C)/(E) (wt/wt) is from >0 to <2).

Optional additive (F) a stabilizer for stabilizing the curable formulation against ultraviolet light (UV stabilizer). The (F) stabilizer is different in composition than the (C) antioxidant, which means when the formulation contains both (C) and (F), the compound used as (C) is different than that used as (F). Examples are a hindered amine light stabilizer (HALS), a benzophenone, or a benzotriazole. The (F) UV stabilizer may be a molecule that contains a basic nitrogen atom that is bonded to at least one sterically bulky organo group and functions as an inhibitor of degradation or decomposition, or a collection of such molecules. The HALS is a compound that has a sterically hindered amino functional group and inhibits oxidative degradation and can also increase the shelf lives of embodiments of the formulation that contain organic peroxide. Examples of suitable (F) are butanedioic acid dimethyl ester, polymer with 4-hydroxy-2,2,6,6-tetramethyl-1-piperidine-ethanol (CAS No. 65447-77-0, commercially LOWILITE 62); and N,N′-bisformyl-N,N′-bis(2,2,6,6-tetramethyl-4-piperidinyl)-hexamethylenediamine (CAS No. 124172-53-8, commercially Uvinul 4050 H). The formulation and product may be free of (F). When present, the (F) UV stabilizer may be from 0.001 to 1.5 wt %, alternatively 0.002 to 1.0 wt %, alternatively 0.05 to 0.1 wt % of the formulation.

Optional additive (G) processing aid: a molecule that decrease adherence of polymer melts in manufacturing equipment such as extruders and dies and to decrease melt fracture of materials. The (G) may be fluoropolymers, polyorganosiloxane fluids, metal salts of fatty carboxylic acids, fatty carboxamides such as N,N′-ethylenebisstearamide, waxes, ethylene oxide (co)polymers, and non-ionic surfactants. The formulation and product may be free of (G). When present, the (G) processing aid may be from 0.05 to 5 wt % of the formulation.

When constituent (A) is the EEA bipolymer and/or constituent (B) is the EBACO terpolymer, the polyethylene copolymer blend, curable formulation cured product, strippable semiconductive insulation shield layer, and methods may further consist essentially of a flame retardant. The flame retardant may be a mineral flame retardant (e.g., aluminum trihydrate) or a non-mineral flame retardant, as described below.

When constituent (A) is the EVA bipolymer and constituent (B) is the EVACO terpolymer, alternatively when constituent (A) is the EVA bipolymer or constituent (B) is the EVACO terpolymer, the polyethylene copolymer blend, curable formulation cured product, strippable semiconductive insulation shield layer, and methods may be free of a mineral flame retardant (free of aluminum trihydrate), but, optionally, may further consist essentially of a non-mineral flame retardant.

The non-mineral flame retardant may be an organohalogen compound, an (organo)phosphorus compound, a halogenated silicone, or a combination of any two or more thereof.

The polyethylene copolymer blend, curable formulation cured product, strippable semiconductive insulation shield layer may optionally further consist essentially of a flame-retardant synergist (e.g., antimony trioxide).

When present, the flame retardant may be from 0.1 to 80.0 wt %, alternatively 1 to 50.0 wt %; and alternatively 5 to 30.0 wt % of the formulation.

The featured additive may be useful for imparting at least one characteristic or property to an embodiment in need thereof, which includes the formulation, product, or method. The characteristic or property may improve performance of the embodiment such as where the embodiment is exposed to elevated temperature as in operations or applications that include melt mixing, extruding, molding, hot water, and insulating (electrical power cable).

Alternatively precedes a distinct embodiment. ASTM means the standards organization, ASTM International, West Conshohocken, Pa., USA. Any comparative example is used for illustration purposes only and shall not be prior art. Free of or lacks means a complete absence of; alternatively not detectable. ISO is International Organization for Standardization, Chemin de Blandonnet 8, CP 401-1214 Vernier, Geneva, Switzerland. IUPAC is International Union of Pure and Applied Chemistry (IUPAC Secretariat, Research Triangle Park, North Carolina, USA). May confers a permitted choice, not an imperative. Operative means functionally capable or effective. Optional(ly) means is absent (or excluded), alternatively is present (or included). PAS is Publicly Available Specification, Deutsches Institut für Normunng e.V. (DIN, German Institute for Standardization) Properties may be measured using standard test methods and conditions. Ranges include endpoints, subranges, and whole and/or fractional values subsumed therein, except a range of integers does not include fractional values. Room temperature: 23° C.±1° C.

Insulation Laminate Preparation Method: Preparation of cured insulation laminates containing a crosslinked insulation layer and a cured insulation shield layer, wherein the crosslinked insulation layer is composed of crosslinked product of curing LDPE Formulation 1 (described later) and the cured insulation shield layer is composed of an inventive or comparative cured polymer product. Separately prepare uncured insulation layer plaques each having a thickness of 3.2 mm (125 mils) by compression molding LDPE Formulation 1 at 140° C. Also, separately prepare 0.76 mm (30 mils) thick uncured inventive or comparative insulation shield plaques via compression molding an inventive or comparative curable composition, respectively, at 140° C. Place one of the uncured insulation plaques (made from LDPE Formulation 1) with smooth surface side up into a 3.2 mm (125 mils) platen. Cover approximately 2.5 cm (1-inch) of one edge of the uncured insulation plaque with a strip of an oriented polyester film (e.g., MYLAR). Place one of the uncured insulation shield plaques (made from the inventive or comparative curable composition) with the smooth surface side down onto the uncured insulation plaque to form an uncured adhesion plaque “sandwich”. Transfer the uncured adhesion plaque “sandwich” into a press set at 120° C., and compress it at pressure 6.9 megapascals (MPa, 1000 pounds per square inch (psi)) for 3 minutes. Increase the pressure to 138 MPa (10 tons per square inch) and increase temperature to 190° C., and continue pressing for about 25 minutes to give a cured insulation laminate containing an insulation layer composed of crosslinked product of curing LDPE formulation 1 (described later) and an insulation shield layer composed of an inventive or comparative cured polymer product, respectively.

Brittleness Failure Test Method: Measure low temperature brittleness at minus 40 degrees Celsius (−40° C.) according to ASTM D746-14, Standard Test Method for Brittleness Temperature of Plastics and Elastomers by Impact.

Density: measured according to ASTM D792-13, Standard Test Methods for Density and Specific Gravity (Relative Density) of Plastics by Displacement, Method B (for testing solid plastics in liquids other than water, e.g., in liquid 2-propanol). Units of grams per cubic centimeter (g/cm³).

Melt Index (“I₂”): measured according to ASTM D1238-13, using conditions of 190° C./2.16 kg, formerly known as “Condition E”. Units of grams per 10 minutes (g/10 min.).

Peak Peel Force Test Method: Measure strip force on an insulation laminate prepared according to the Insulation Laminate Preparation Method described earlier. Cut the insulation laminate into 5 test specimens, each of which contains a 1.27 cm (0.5 inch) wide cut strip through insulation shield layer. Mount the “plaque sandwich” on a rotatable wheel and grip the insulation shield strip in the upper grip clamp with a contentious 90° peel set up in an Instron 4201 machine. Conduct a peel test at a rate of 50.8 cm (20 inches) per minute and record the peak peel force in Newtons per centimeter (N/cm).

Volume Resistivity Test Method: Measure resistivity of samples with low resistivity (<10⁸ Ohm-cm (Ω·cm)) using a Keithley 2700 Integra Series digital multimeter with 2-point probe. Apply silver paint (conductive silver #4817N) to minimize contact resistance between the samples and electrodes, wherein the sample is a compression molded plaque sample prepared by the Compression Molded Plaque Preparation Method with thickness of 1.905 to 1.203 mm (75 mils to 80 mils), length of 101.6 mm, and width of 50.8 mm.

### EXAMPLES

LDPE Formulation 1: a curable (not crosslinked) low-density polyethylene formulation that comprises 99 wt % of a base polymer and 1 wt % of an additive package, wherein the base polymer is a low-density polyethylene homopolymer having a density of 0.92 g/cm³ and melt index (I₂) of 1.8 g/10 min.; and wherein the additive package comprises an organic peroxide, at least one tree retardant, and at least one antioxidant.

Inventive (A)1: an EVA bipolymer having 32 wt % vinyl acetate comonomeric content and a melt index (I₂) of 30 g/10 min. From The Dow Chemical Company.

Inventive (A)2: an EEA bipolymer having 18 wt % ethyl acrylate comonomeric content and a melt index (I₂) of 6 g/10 min. From The Dow Chemical Company.

Inventive (B)1: an EVACO terpolymer having 20.5 wt % vinyl acetate comonomeric content and 8 wt % carbon monoxide comonomeric content and a melt index (I₂) of 15 g/10 min. From The Dow Chemical Company.

Inventive (B)2: an EBACO terpolymer having 30 wt % butyl acrylate comonomeric content and 10 wt % carbon monoxide comonomeric content and a melt index (I₂) of 8 g/10 min. From The Dow Chemical Company.

Inventive (B)3: an EBACO terpolymer having 30 wt % butyl acrylate comonomeric content and 10 wt % carbon monoxide comonomeric content and a melt index (I₂) of 12 g/10 min. From The Dow Chemical Company.

Inventive (B)4: EVACO terpolymer having 24 wt % vinyl acetate comonomeric content and 10 wt % carbon monoxide content and a melt index (I₂) of 35 g/10 min. From The Dow Chemical Company.

Comparative (B)5: EBACO terpolymer having 30 wt % butyl acrylate comonomeric content and 13 wt % carbon monoxide comonomeric content and a melt index (I₂) of 12 g/10 min. From The Dow Chemical Company.

Inventive (C)1: antioxidant butylated hydroxy toluene (BHT).

Inventive (C)2: antioxidant octadecyl 3-(3,5-di-tert-butyl-4-hydroxyphenyl)propanoate. NAUGARD 76.

Inventive (D)1: carbon black CSX-614.

Inventive (E)1: organic peroxide bis(t-butyl peroxy isopropyl)benzene. LUPEROX D446B.

Inventive (F)1: hindered amine stabilizer bis(4-(1-methyl-1-phenylethyl)phenyl)amine. NAUGARD 445.

Inventive (G)1: processing aid N,N′-ethylenebisstearamide. Kenamide W40.

Inventive Examples 1A to 8A (IE1A to IE8A): (prophetic) prepare polyethylene copolymer blends by mixing constituent (A)1 or (A)2 with constituent (B)1, (B)2, or (B)3 as shown in Table 1 in Brabender mixer ball with roller blade at 140° C. at 40 rotations per minute (rpm) for 5 minutes to give polyethylene copolymer blends IE1A to IE8A, respectively. Separately extrude each blend into a single strand, and pelletize the strand in ambient conditions.

Inventive Examples 1B to 8B (IE1B to IE8B): prepare curable formulations by mixing all constituents shown in Table 1 in Brabender mixer ball with roller blade at 140° C. at 40 rotations per minute (rpm) for 5 minutes to give curable formulations IE1B to IE8B. Separately extrude the curable formulations into a single strand, and pelletize the strand in ambient conditions to give the formulations as pellets.

Inventive Examples 1C to 8C (IE1C to IE8C): Separately soak the pellets of curable formulation of Inventive Examples 1B to 8B with constituent (E)1 at a weight/weight ratio of 0.7 g (E)1 per 100 g pellets at 45° C. overnight to give pellets of curable formulations IE1C to IE8C. After soaking, use the soaked pellets of IE1C to IE8C to make insulation laminates for peak peel force testing and crosslinked plaques for volume resistivity and brittleness testing.

Inventive Examples 1D to 8D (IE1 D to IE8D): cured polymer products. Prepare cured insulation laminates according to the Insulation Laminate Preparation Method wherein the cured insulation shield layer is a cured polymer product of curing one of the curable formulations of Inventive Examples 10 to 8 C, respectively. Measure strip force on the insulation laminate according to the Peak Peel Force Test Method described earlier.

Comparative Examples 1A to 2A (CE1A and CE2A): (prophetic) prepare comparative polymer blends. Replicate the procedure of Inventive Example 1 A and 3A, respectively, except use comparative (B)5 in place of inventive (B)1 to give comparative polyethylene copolymer blends CE1A and CE2A, respectively, as pellets.

Comparative Examples 1B to 2B (CE1B and CE2B): replicate the procedure of Inventive Examples 1B and 3B, respectively, except use comparative (B)5 in place of inventive (B)1 to give comparative curable formulations CE1B and CE2B, respectively.

Comparative Examples 1C to 2C (CE1C and CE2C): replicate the procedure of Inventive Examples 1C and 3C, respectively, except use Comparative Examples CE1B and CE2B in place of IE1B and IE3B, respectively to give comparative curable formulations CE1C and CE2C, respectively.

Comparative Examples 1D to 2D (CE1D and CE2D): comparative cured polymer products. Replicate the procedure of Inventive Examples 1D and 3D, respectively, except use Comparative Examples CE1C and CE2C in place of IE1C and IE3C, respectively to give comparative cured polymer products CE1D and CE2D, respectively.

Use crosslinked plaque for volume resistivity measurement at room temperature, the test procedure is according to ASTM D991 and for brittleness test at −40° C. according to ASTM D746. Record the number of failures out of 10 test specimens tested.

Compositions and test results of inventive examples are shown later in Tables 1 to 4. Compositions and test results of comparative examples are shown later in Tables 5 to 8.

TABLE 1
polyethylene copolymer blends of prophetic Inventive Examples 1A to 8A.

| Ex. No. | Ingredient (A) (wt %) | Ingredient (B) (wt %) | Total (wt %) |
|---|---|---|---|
| IE1A | 83.2 | 16.8 | 100 |
| IE2A | 75.0 | 25.0 | 100 |
| IE3A | 50.0 | 50.0 | 100 |
| IE4A | 83.2 | 16.8 | 100 |
| IE5A | 83.2 | 16.8 | 100 |
| IE6A | 76.6 | 23.4 | 100 |
| IE7A | 83.2 | 16.8 | 100 |
| IE8A | 50.0 | 50.0 | 100 |

TABLE 2
curable formulations Inventive Examples 1B to 8B.

| Ingredient | IE1B | IE2B | IE3B | IE4B | IE5B | IE6B | IE7B | IE8B |
|---|---|---|---|---|---|---|---|---|
| (A)1 | 49.90 | 44.95 | 29.95 | 49.90 | 49.90 | 49.2 | 0 | 0 |
| (A)2 | 0 | 0 | 0 | 0 | 0 | 0 | 49.9 | 29.95 |
| (B)1 | 10.05 | 15.00 | 30.00 | 0 | 0 | 15.0 | 0 | 0 |
| (B)2 | 0 | 0 | 0 | 10.05 | 0 | 0 | 10.05 | 30 |
| (B)3 | 0 | 0 | 0 | 0 | 10.05 | 0 | 0 | 0 |
| (C)1 | 0 | 0.32 | 0.32 | 0 | 0 | 0.32 | 0 | 0 |
| (C)2 | 0 | 0.48 | 0.48 | 0 | 0 | 0.48 | 0 | 0 |
| (D)1 | 38.25 | 38.25 | 38.25 | 38.25 | 38.25 | 34.0 | 38.25 | 38.25 |
| (F)1 | 0.80 | 0 | 0 | 0.80 | 0.80 | 0 | 0.8 | 0.8 |
| (G)1 | 1.00 | 1.00 | 1.00 | 1.00 | 1.00 | 1 | 1 | 1 |
| Total | 100 | 100 | 100 | 100 | 100 | 100 | 100 | 100 |

TABLE 3
curable formulations of Inventive Examples 1C to 8C.

| Ingredient | IE1C | IE2C | IE3C | IE4C | IE5C | IE6C | IE7C | IE8C |
|---|---|---|---|---|---|---|---|---|
| IE1B | 100 | 0 | 0 | 0 | 0 | 0 | 0 | 0 |
| IE2B | 0 | 100 | 0 | 0 | 0 | 0 | 0 | 0 |
| IE3B | 0 | 0 | 100 | 0 | 0 | 0 | 0 | 0 |
| IE4B | 0 | 0 | 0 | 100 | 0 | 0 | 0 | 0 |
| IE5B | 0 | 0 | 0 | 0 | 100 | 0 | 0 | 0 |
| IE6B | 0 | 0 | 0 | 0 | 0 | 100 | 0 | 0 |
| IE7B | 0 | 0 | 0 | 0 | 0 | 0 | 100 | 0 |
| IE8B | 0 | 0 | 0 | 0 | 0 | 0 | 0 | 100 |
| (E)1 | 0.7 | 0.7 | 0.7 | 0.7 | 0.7 | 0.7 | 0.7 | 0.7 |
| Total | 100.7 | 100.7 | 100.7 | 100.7 | 100.7 | 100.7 | 100.7 | 100.7 |

TABLE 4
properties of insulation laminates containing insulation shield layers
composed of cured polymer products of Inventive Examples 1D to 8D.

| Property | IE1D | IE2D | IE3D | IE4D | IE5D | IE6D | IE7D | IE8D |
|---|---|---|---|---|---|---|---|---|
| Log (Volume | 1.6 | 1.6 | 1.7 | 1.9 | 1.9 | 1.6 | 1.6 | 1.7 |
| Resistivity) | | | | | | | | |
| at 23° C. | | | | | | | | |
| (Ohm-cm) | | | | | | | | |
| Brittleness | 6 | 0 | 0 | 3 | 0 | 0 | 1 | 0 |
| failure at | | | | | | | | |
| 40° C. (number of | | | | | | | | |
| failures out of 10 | | | | | | | | |
| specimens tested) | | | | | | | | |
| Peak Peel Force | 57.9 | 46.8 | 46 | 46.8 | 53.3 | 31.6 | Bnd* | Bnd |
| (N/cm) | | | | | | | | |

*Bnd means bonded, i.e., did not peel.

TABLE 5
polyethylene copolymer blends of prophetic Comparative Examples 1A to 2A

| Ex. No. | Ingredient (A) (wt %) | Ingredient (B) (wt %) | Total (wt %) |
|---|---|---|---|
| CE1A | 83.2 | 16.8 | 100 |
| CE2A | 75.0 | 25.0 | 100 |

TABLE 6
curable formulations Comparative Examples 1B to 2B

| Ingredient | CE1B | CE2B |
|---|---|---|
| (A)1 | 49.90 | 29.95 |
| (B)5 | 10.05 | 30.00 |
| (C)1 | 0 | 0 |
| (C)2 | 0 | 0 |
| (D)1 | 38.25 | 38.25 |
| (F)1 | 0.80 | 0.80 |
| (G)1 | 1.00 | 1.00 |
| Total | 100 | 100 |

TABLE 7
curable formulations of Comparative Examples 1C to 2C.

| Ingredient | CE1C | CE2C |
|---|---|---|
| CE1B | 100 | 0 |
| CE2B | 0 | 100 |
| (E)1 | 0.7 | 0.7 |
| Total | 100.7 | 100.7 |

TABLE 8
properties of insulation laminates containing insulation shield layers
composed of cured polymer products of Comparative Examples 1D to 2D.

| Property | CE1D | CE2D |
|---|---|---|
| Log(Volume Resistivity) at 23° C. (Ohm-cm) | 2.5 | 2.4 |
| Brittleness failure at 40° C. (number of failures | 3 | 9 |
| out of 10 specimens tested) | | |
| Peak Peel Force (N/cm) | 52 | Bnd* |

*Bnd means bonded, i.e., did not peel..

Comparing the inventive data in Table 4 with the comparative data in Table 8, the inventive polyethylene copolymer blends, curable formulations and cured polymer products have significantly improved (decreased) log(volume resistivity) at 23° C., overall improved (decreased) brittleness failure at 40° C. out of ten specimens, and comparable or improved (decreased) peak peel force. The comparative blends, formulations, and products are based on an ethylene/unsaturated carboxylic ester/carbon monoxide terpolymer having 13 wt % carbon monoxide comonomeric content, whereas the inventive blends, formulations, and products are based on an ethylene/unsaturated carboxylic ester/carbon monoxide terpolymer having from 7 to 11 wt % carbon monoxide comonomeric content.

Inventive Example 2A to 2D (IE2A to IE2D) (prophetic): replicate IE1A, IE1B, IE1C, and IE1D except use constituent (B)4 in place of constituent (B1) to give inventive examples IE2A, IE2B, IE2C, and IE2D, respectively. IE2A, IE2B, and IE2C have the compositions described for IE1A, IE1B, and IE1C in Tables 1 to 3, respectively, except (B)4 is used in place of (B)1. IE2D is a cured insulation laminate wherein the insulation shield layer is made of a cured product made by a method as described for IE1D except the cured product is made from IE2C instead of IE1C.

1. A polyethylene copolymer blend consisting essentially of from 46 to 85 wt % of (A) an ethylene/unsaturated carboxylic ester bipolymer (“constituent (A)”) and from 54 to 15 wt % of (B) an ethylene/unsaturated carboxylic ester/carbon monoxide terpolymer (“constituent (B)”), based on the total weight of (A) and (B); wherein the (A) ethylene/unsaturated carboxylic ester bipolymer is an ethylene/vinyl acetate (EVA) bipolymer or ethylene/ethyl acrylate (EEA) bipolymer and the bipolymer has an unsaturated carboxylic ester comonomeric content from 18 to 33 wt % and a melt index (I₂; 190° C., 2.16 kg) from 5 to 35 g/10 min.; and wherein the (B) ethylene/unsaturated carboxylic ester/carbon monoxide terpolymer is an ethylene/vinyl acetate/carbon monoxide (EVACO) terpolymer or an ethylene/butyl acrylate/carbon monoxide (EBACO) terpolymer and the terpolymer has unsaturated carboxylic ester comonomeric content from 19 to 32 wt %, carbon monoxide comonomeric content from 7 to 11 wt %, and a melt index (I₂; 190° C., 2.16 kg) from 6 to 39 g/10 min.; wherein the polyethylene copolymer blend is free of at least one of materials (i) to (iii), and, optionally material (iv): (i) a mineral filler, (ii) an olefin-functional hydrolyzable silane, and (iii) a reaction product of a reaction of a reactant with the mineral filler and/or the olefin-functional hydrolyzable silane, and, optionally, (iv) a nitrile butadiene rubber.

2. The polyethylene copolymer blend of claim 1 having any one of features (a) to (d): (a) wherein constituent (A) is the ethylene/vinyl acetate (EVA) bipolymer and constituent (B) is the ethylene/vinyl acetate/carbon monoxide (EVACO) terpolymer and the polyethylene copolymer blend is free of at least one of, alternatively any two of, alternatively each of materials (i) to (iii); (b) wherein constituent (A) is an EVA bipolymer and constituent (B) is the ethylene/butyl acrylate/carbon monoxide (EBACO) terpolymer; (c) wherein constituent (A) is the ethylene/ethyl acrylate (EEA) bipolymer and constituent (B) is the EVACO terpolymer; (b) wherein constituent (A) is the EEA bipolymer and constituent (B) is the EBACO terpolymer; and (e) any one of features (b) to (d) wherein the polyethylene copolymer blend is free of at least one of materials (i) to (iii) and, optionally material (iv).

3. The polyethylene copolymer blend of claim 1 consisting essentially of from 46 to 85 wt % of the (A) ethylene/unsaturated carboxylic ester bipolymer and from 54 to 15 wt % of the (B) an ethylene/unsaturated carboxylic ester/carbon monoxide terpolymer, based on the total weight of (A) and (B); wherein the (A) ethylene/unsaturated carboxylic ester bipolymer is an ethylene/vinyl acetate (EVA) bipolymer that has an unsaturated carboxylic ester comonomeric content from 27 to 33 wt % and a melt index (I₂; 190° C., 2.16 kg) from 25 to 35 g/10 min. or the (A) ethylene/unsaturated carboxylic ester bipolymer is an ethylene/ethyl acrylate (EEA) bipolymer that has an unsaturated carboxylic ester comonomeric content from 15 to 21 wt % and a melt index (I₂; 190° C., 2.16 kg) from 5 to 9 g/10 min.; and wherein the (B) ethylene/unsaturated carboxylic ester/carbon monoxide terpolymer is an ethylene/vinyl acetate/carbon monoxide (EVACO) terpolymer that has unsaturated carboxylic ester comonomeric content from 19 to 25 wt %, carbon monoxide comonomeric content from 7 to 11 wt %, and a melt index (I₂; 190° C., 2.16 kg) from 14 to 36 g/10 min or the (B) ethylene/unsaturated carboxylic ester/carbon monoxide terpolymer is an ethylene/butyl acrylate/carbon monoxide (EBACO) terpolymer that has an unsaturated carboxylic ester comonomeric content from 25 to 32 wt %, carbon monoxide comonomeric content from 9 to 11 wt %, and a melt index (I₂; 190° C., 2.16 kg) from 6 to 15 g/10 min.

4. The polyethylene copolymer blend of claim 3 selected from any one of polyethylene copolymer blends (1) to (8): (1) 83 wt % of constituent (A) that is an EVA bipolymer having 32 wt % vinyl acetate comonomeric content and a melt index (I₂) of 30 g/10 min and 17 wt % of constituent (B) that is an EVACO terpolymer having 20 to 21 wt % vinyl acetate comonomeric content and 8 wt % carbon monoxide comonomeric content and a melt index (I₂) of 15 g/10 min.; (2) 75 wt % of constituent (A) that is an EVA bipolymer having 32 wt % vinyl acetate comonomeric content and a melt index (I₂) of 30 g/10 min. and 25 wt % of constituent (B) that is an EVACO terpolymer having 20 to 21 wt % vinyl acetate comonomeric content and 8 wt % carbon monoxide comonomeric content and a melt index (I₂) of 15 g/10 min.; (3) 50 wt % of constituent (A) that is an EVA bipolymer having 32 wt % vinyl acetate comonomeric content and a melt index (I₂) of 30 g/10 min and 50 wt % of constituent (B) that is an EVACO terpolymer having 20 to 21 wt % vinyl acetate comonomeric content and 8 wt % carbon monoxide comonomeric content and a melt index (I₂) of 15 g/10 min; (4) 83 wt % of constituent (A) that is an EVA bipolymer having 32 wt % vinyl acetate comonomeric content and a melt index (I₂) of 30 g/10 min. and 17 wt % of constituent (B) that is an EBACO terpolymer having 30 wt % butyl acrylate comonomeric content and 10 wt % carbon monoxide comonomeric content and a melt index (I₂) of 8 g/10 min.; (5) 83 wt % of constituent (A) that is an EVA bipolymer having 32 wt % vinyl acetate comonomeric content and a melt index (I₂) of 30 g/10 min. and 17 wt % of constituent (B) that is an EBACO terpolymer having 30 wt % butyl acrylate comonomeric content and 10 wt % carbon monoxide comonomeric content and a melt index (I₂) of 12 g/10 min.; (6) 77 wt % of constituent (A) that is an EVA bipolymer having 32 wt % vinyl acetate comonomeric content and a melt index (I₂) of 30 g/10 min. and 23 wt % of constituent (B) that is an EVACO terpolymer having 20 to 21 wt % vinyl acetate comonomeric content and 8 wt % carbon monoxide comonomeric content and a melt index (I₂) of 15 g/10 min.; (7) 83.2 wt % of constituent (A) that is an ethylene/ethyl acrylate (EEA) bipolymer having 18 wt % ethyl acrylate comonomeric content and a melt index (I₂) of 6 g/10 min. and 16.8 wt % of constituent (B) that is an EBACO terpolymer having 30 wt % butyl acrylate comonomeric content and 10 wt % carbon monoxide comonomeric content and a melt index (I₂) of 8 g/10 min.; and (8) 50 wt % of constituent (A) that is an ethylene/ethyl acrylate (EEA) bipolymer having 18 wt % ethyl acrylate comonomeric content and a melt index (I₂) of 6 g/10 min. and 50 wt % of constituent (B) that is an EBACO terpolymer having 30 wt % butyl acrylate comonomeric content and 10 wt % carbon monoxide comonomeric content and a melt index (I₂) of 8 g/10 min.

5. A curable formulation consisting essentially of the polyethylene copolymer blend of claim 1 and at least one additive that is not a mineral filler and/or an olefin-functional hydrolyzable silane (“the featured additive”) selected from the group consisting of additives (C) to (I): (C) an antioxidant; (D) a carbon black; (E) an organic peroxide; (F) a stabilizer for stabilizing the formulation against effects of ultraviolet light; (G) a processing aid; (H) any four of additives (C) to (G); and (I) each of additives (C) to (G).

6. The curable formulation of claim 5 wherein the at least one featured additive includes the (C) antioxidant and (D) carbon black; and optionally includes the (E) organic peroxide; optionally the (F) stabilizer for stabilizing the formulation against effects of ultraviolet light; and optionally the (G) processing aid.

7. A method of making a curable formulation of claim 5, the method consisting essentially of mixing a melt of (A) ethylene/unsaturated carboxylic ester and (B) ethylene/unsaturated carboxylic ester/carbon monoxide terpolymer and the at least one featured additive, so as to give a melt-mixture consisting essentially of the melt of (A) and (B) and the at least one featured additive; and extruding the melt-mixture so as to make the curable formulation.

8. A method of making a cured polymer product, the method consisting essentially of curing (irradiating or heating with (E) organic peroxide) the curable formulation of claim 5 so as to give the cured polymer product.

9. A cured polymer product made by the method of claim 8.

10. A strippable semiconductive insulation shield layer consisting essentially of a shaped form of a cured polymer product made by curing with (E) organic peroxide the curable formulation of claim 6.

11. A coated conductor sequentially consisting essentially of a conductive core, a semiconductive shield layer, an insulation layer, the strippable semiconductive insulation shield layer made of the cured polymer product of claim 10, and, optionally, an outer sheath.

12. A method of conducting electricity, the method consisting essentially of applying a voltage across the conductive core of the coated conductor of claim 11 so as to generate a flow of electricity through the conductive core.

13. An insulation laminate consisting essentially of an insulation layer and an strippable insulation shield layer, which is in direct physical contact with the insulation layer; wherein the insulation layer comprises a cured polyethylene that is free of carbon black and wherein the strippable insulation shield layer consists essentially of a cured product of curing a curable formulation consisting essentially of the polyethylene copolymer blend of claim 1; (C) an antioxidant; (D) a carbon black; and (E) an organic peroxide.
